(19) United States
(12) Patent Application Publication
(10) Pub. No.: US 2016/0232543 A1
(43) Pub. Date: Aug. 11, 2016

(54) Predicting Interest for Items Based on Trend Information

(71) Applicant: salesforce.com, Inc., San Francisco, CA (US)

(72) Inventors: Jayesh Govindarajan, Palo Alto, CA (US); Naren Chittar, San Jose, CA (US)

(21) Appl. No.: 15/014,863

(22) Filed: Feb. 3, 2016

Related U.S. Application Data
(60) Provisional application No. 62/176,058, filed on Feb. 9, 2015.

(51) Int. Cl. G06Q 30/02; G06N 5/04

(52) U.S. Cl. CPC G06Q 30/0202; G06N 5/04

(57) ABSTRACT

A predictive demand system receives a request from a client device to predict interest for an item. The predictive demand system identifies a description of the item included with the request. The predictive demand system identifies topics included in the description and calculates a topic score for each identified topic. If trend information is available for an identified topic, the topic score is determined based on the trend information of the topic. If trend information is not available for the identified topic, the topic score is determined based on trend information of related topics. The predictive demand system determines a predictive score for the item based on the topic scores of the topics included in the item description. The predictive score indicates predicted interest in the item.

### CROSS-REFERENCE TO RELATED APPLICATION

This application claims the benefit of U.S. Provisional Application No. 62/176,058, filed Feb. 9, 2015, which is hereby incorporated herein by reference.

### BACKGROUND

1. Field of the Embodiments

Described embodiments pertain in general to predicting interest for items, and in particular to predicting interest for items based on trend information.

2. Description of the Related Art

Online merchants have various ways of determining whether users are interested in products that they sell. For example, a merchant having a website online can obtain various metrics from user interactions with the website which indicate user interest in a product. Metrics may include the number of times users have searched for the product, the number of times the product has been viewed on the website, and the number of times the product has been purchased. However, when the merchant is interested in offering a new product, it is difficult for the merchant to determine whether users will be interested in the new product since the merchant has no metrics on past performance of the product. If the merchant is wrong in predicting high demand for a new product, it can be very costly to the merchant in terms of resources spent on promoting the product (e.g., online advertising) and in terms of unsold inventory.

### SUMMARY

The embodiments described herein provide methods, computer program products, and computer database systems for predicting interest for items based on trend information. In one embodiment, a predictive demand system generates trend information for different topics. One type of trend information generated by the predictive demand system is merchant trend information which is generated based on user interactions with a merchant system 102 associated with the predictive demand system.

To generate the merchant trend information, the predictive demand system identifies pages through with the merchant system offers merchant items for purchase and determines topics included in the pages. The predictive demand system tracks user interactions with the pages. Interactions with a page are associated with the topics included in the page. For example, merchant trend information generated for a topic may include for different time periods the number of times pages that include the topic were viewed.

Another type of trend information generated by the predictive demand system is external trend information. External trend information is generated based on content items obtained from sources that are separate from the merchant system 102. The content items may be, for example, published articles, RSS feeds, and social media information. Each content item is analyzed for topics. If a content item includes a topic, information is stored by the predictive demand system as external trend information which indicates that the topic was included in the content item. External trend information for a topic indicates for different time periods the number of times the topic was included in content items obtained by the predictive demand system.

When a user wishes to determine the likely interest/demand that there will be for a new merchant item, the user provides to the predictive demand system a description of the merchant item. For example, for a clothing item, the user may provide a brand, style, color, and price of the clothing item. The predictive demand system identifies topics included in the description (e.g., brand, style, color, and price).

For each identified topic, the predictive demand system determines a topic score which is a measure that indicates the predicted interest in the topic. To determine the topic score for an identified topic, the predictive demand system determines whether trend information (merchant and/or external trend information) has been generated for the identified topic. If trend information has been generated for the identified topic, the predictive demand system determines the topic score for the topic based on the trend information.

However, if trend information has not been generated for the identified topic, the predictive demand system determines one or more topics related to the identified topic and for which the predictive demand system has generated trend information. The one or more related topics are determined based on the other topics included in the description of the merchant item. For example, if the merchant description is describing a high end shoe by a new brand and if there is no trend information for the new brand, the predictive demand system may identify other brands that make high end shoes as related topics. The predictive demand system determines the topic score for the identified topic based on the trend information of the related topics.

The predictive demand system determines a predictive score for the merchant item based on topic scores determined for the identified topics. The predictive score is a measure that indicates the predicted interest that users will have for the merchant item. The predictive demand system provides the predictive score to the user that provided the merchant item description. For example, the user can be a merchandise buyer for the merchant of the merchant system and based on the predictive score, the user can make a decision as to whether to offer the merchant item through the merchant system. In another example, the user can be a marketing employee of the merchant and based on the predictive score, the user can make a decision as to whether to market the merchant item.

Hence, the predictive demand system is able to predict interest in a merchant item by breaking down the merchant item description into topics. By breaking down the description into topics, the predictive demand system can predict interest for an item when very specific information is provided for the item (e.g., brand, style, color, and price) or when a general keyword description is provided (e.g., poke dot blouse).

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a block diagram of a prediction environment according to one embodiment.

FIG. 2 is a block diagram illustrating components of a predictive demand system according to one embodiment.

FIG. 3 is a flow chart illustrating operations of the predictive demand system in predicting demand for an item according to one embodiment.

FIG. 4 is a block diagram illustrating a functional view of a typical computer system for use as one of the entities illustrated in the environment of FIG. 1 according to an embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

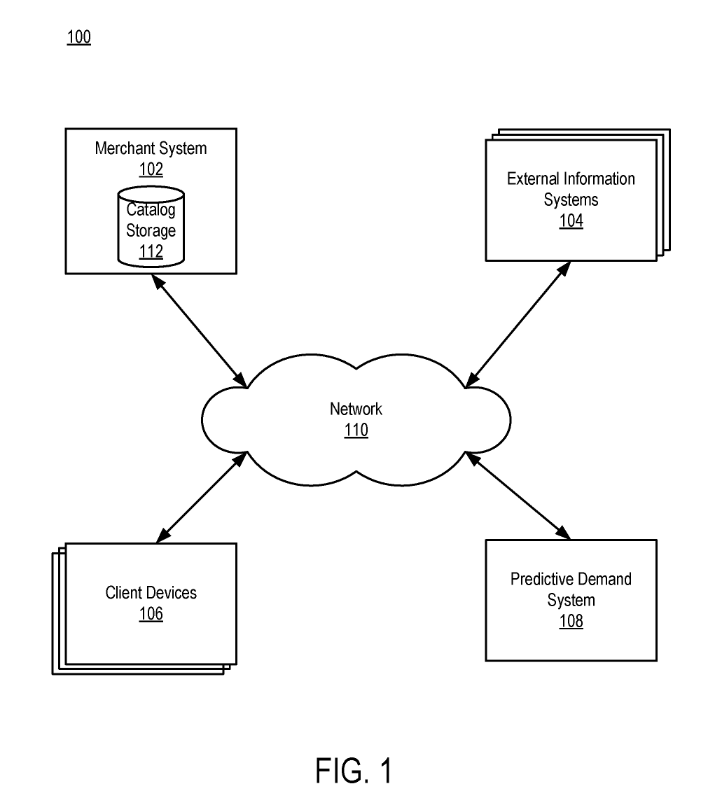

FIG. 1 is a block diagram of a prediction environment 100 according to one embodiment. FIG. 1 illustrates a merchant system 102, multiple external information systems 104, multiple client devices 106, and a predictive demand system 108 connected via a network 110. Although a select number of each entity are shown in FIG. 1, embodiments can have more or less of each entity (e.g., additional external information systems 104 and client device 106).

The merchant system 102 is a computer system through which a merchant offers merchant items to users. The merchant items offered by the merchant system 102 may be tangible items (e.g., clothing, electronics, and furniture) that are shipped to a user after being purchased by the user through the merchant system 102. The merchant items may also be electronic files (e.g., music, video, and movie files) that can be transmitted to a user's client device 106 via the network 110. The merchant items offered by the merchant system 102 may be available for users to purchase or may be offered at no cost.

The merchant system 102 includes a catalog storage 112 that stores information on the various merchant items offered through the merchant system 102. For each merchant item, the catalog storage 112 may store information that includes a description of the merchant item, a maker of the item, a price at which the item is offered, user feedback regarding the item (e.g., user reviews), and other characteristics associated with the item. The merchant system 102 provides to user's client devices 106 pages that include merchant item information from the catalog storage 112. A page may be, for example, a web page or mobile applications.

If a user provides a search query for a merchant item, the merchant system 102 searches the catalog storage 112 for items that match the search query. The merchant system 102 generates and provides to the user's client device 106 search results that include merchant items that match the search query. If the user selects a merchant item, the merchant system 102 provides a page to the client device 106 that includes information in the catalog storage 112 that is associated with the merchant item.

If the user requests a merchant item (e.g., requests to purchase the merchant item), the merchant system 102 communicates with the user's client device 106 to allow the user to be able to obtain the item. For example, the user may add the merchant item to an electronic shopping cart. When the user requests to purchase the item in the shopping cart, the merchant system 102 requests payment information from the user. The merchant system 102 completes the purchase of the merchant item based on the payment information.

External information systems 104 are computer systems that provide access to content items. The external information systems 104 are separate from the merchant system 102 (e.g., operated by entities different than the merchant of the merchant system 102). An external information system 104 may be, for example, a social networking service, an article publisher, a blog site, etc. The external information systems 104 host content items and provide content items to entities that request the content items. A content item may be, for example, a published article, a blog post, an RSS feed, and content shared by a user of a social networking service with other users.

A client device 106 is a device used by a user to communicate with the entities connected to the network 110. A client device 106 may be, for example, a personal computer, smart phone, tablet computer, or personal digital assistant (PDA). Through a client device 106 a user may communicate with the predictive demand system 108 and request a prediction of the interest that users are likely to have for a merchant item. The user includes with the request a description of the merchant item.

In one embodiment, the user is associated with the merchant of the merchant system 102. For example, the user may be an employee or consultant of the merchant, such as a merchandise buyer or a marketing employee. A merchandise buyer may make the request for a new product to determine whether the merchant's customers or people in general will be interested in the product. A marketing employee may make the request to determine a marketing strategy for a new product.

Based on the request, the client device 106 receives from the predictive demand system 108 a predictive score for the merchant item. The predictive score is a measure indicative of the predicted interest that users will have for the merchant item.

The predictive demand system 108 is a computer system that predicts interest for items based on trend information. The predictive demand system 108 generates trend information for a variety of topics. A topic is one or more words that may be related with an item. Trend information of a topic is in indicator of past interest in the topic. There are at least two types of trend information generated by the predictive demand system 108, merchant trend information and external trend information.

Merchant trend information is generated by the predictive demand system 108 based on user interactions with the merchant system 102. Since merchant trend information is determined based on user interactions with the merchant system 102, merchant trend information indicates past interest of the merchant system's 102 users. External trend information is generated based on information obtained from the external information systems 104. Since external information systems 104 are separate from the merchant system 102, the external trend information indicates the interest of users in general and not just the interest of the merchant system's 102 users.

The predictive demand system 108 receives requests from client devices 106 to predict interest for merchant items. When the predictive demand system 108 receives a request from a client device 106 to predict interest for a merchant item, the predictive demand system 108 identifies a description of the merchant item included with the request. The predictive demand system 108 identifies topics included in the description. The predictive demand system 108 calculates a topic score for each identified topic that indicates the predicted interest in the topic.

To determine the topic score for an identified topic, the predictive demand system 108 determine whether merchant or external trend information has been generated for the topic. If merchant trend information and/or external trend information has been generated for the topic, the predictive demand system 108 determines the topic score for the topic based on the trend information.

If trend information has not been generated for the identified topic, the predictive demand system 108 determines topics related to the identified topic for which trend information has been generated. The predictive demand system 108 determines the related topics based on the other identified topics of the item description. For a topic there may be no trend information because it is a new topic that the predictive demand system 108 has not come across. For example, the topic may be a new style. As a result, the topic may not be included in the information obtained from the merchant system 102 or in the information obtained from the external information systems 104 and the predictive demand system 108 will not have generated information for the topic.

The predictive demand system 108 identifies trend information for the related topics. The predictive demand system 108 determines the topic score for the identified topic based on the trend information of the related topics.

In one embodiment, if trend information exists for an identified topic but the predictive demand system 108 determines that there isn't sufficient trend information (e.g., don't have trend information over a minimum time period), the predictive demand system 108 will determine the topic score of the identified topic based on the trend information of related topics. In another embodiment, the predictive demand system 108 determines the topic score for an identified topic using trend information of related topics regardless of whether trend information has been generated for the identified topic.

The predictive demand system 108 determines a predictive score for the merchant item by combining the topic scores of the topics included in the item description. The predictive demand system 108 provides the predictive score to the client device 106 that provided the request.

The network 110 represents the communication pathways between the merchant system 102, the external information system 104, client devices 106, and predictive demand systems 108. In one embodiment, the network 110 is the Internet and uses standard communications technologies and/or protocols. Thus, the network 110 can include links using technologies such as Ethernet, 802.11, worldwide interoperability for microwave access (WiMAX), 3G, Long Term Evolution (LTE), digital subscriber line (DSL), asynchronous transfer mode (ATM), InfiniBand, PCI Express Advanced Switching, etc. Similarly, the networking protocols used on the network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc.

The data exchanged over the network 110 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above.

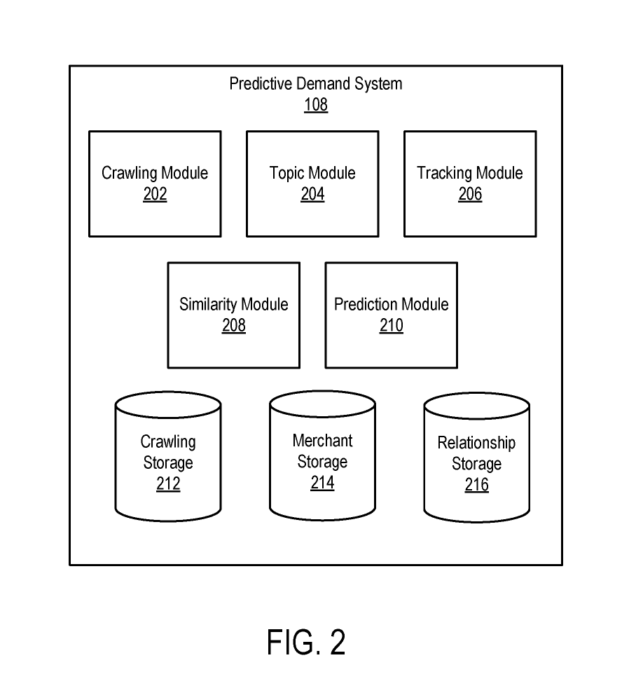

FIG. 2 is a block diagram illustrating components of the predictive demand system 108 according to one embodiment. The predictive demand system 108 includes a crawling module 202, a topic module 204, a tracking module 206, a similarity module 208, a prediction module 210, a crawling storage 212, a merchant storage 214, and a relationship storage 216. Those of skill in the art will recognize that other embodiments can have different and/or other components than the ones described here, and that the functionalities can be distributed among the components in a different manner.

The crawling module 202 communicates with the external information system 104 to obtain content items hosted by the external information systems 104. As described above, a content item may be a published article, a blog post, an RSS feed, or content shared by users of social networking service. The crawling module 202 periodically (e.g., once a day or every hour) communicates with the external information system 104 to determine whether new content items are available. If new content items have been made available by an external information system 104, the crawling module 202 obtains the new content items from the external information system 104.

For each content item obtained from an external information system 104, the crawling module 202 associates timing information with the content item. The timing information may be, for example, the time and date when the content item was made available by the external information system 104 (e.g., when content item was published by the system 104) or the time and date when the content item was obtained by the crawling module 202 from the external information system 104.

The topic module 204 identifies topics included in information obtained from the external information system 104 and the merchant system 102. When the crawling module 202 obtains a content item from an external information system 104, the topic module 204 analyzes the content item to identify topics included in the content item. To identify the topics included in the content item, the topic module 204 classifies the content item under a category. For example, the potential categories under which a content item may be categorized include, fashion, sports, home décor, music, gaming, etc. In one embodiment, the topic module 204 uses a machine learning model to classify the content item. For each potential category, the machine learning model is trained by providing the model example content items that fall under the category and examples that do not fall under the category.

The topic module 204 identifies a topic list associated with the category under which the content item has been classified. The topic list includes multiple topics associated with the category. For example, if the category is fashion, the fashion topic list may include as topics: poke dot blouse, leather boots, and flannel shirt. The topic module 204 searches the content item for the topics included in the topic list.

Additionally, the topic module 204 searches the topic content item for topics associated with the category that are not included in the topic list. To search for these topics, the topic module 204 performs natural language processing on the content item. In one embodiment, the natural language processing includes the topic module 204 searching for one or more words that meet specific criteria. For example, the topic module 204 may search the content item for an adjective that is followed by a noun, such as “floral blouse.” In one embodiment, the criteria used by the topic module 204 to search for topics depends on the classification of the content item. For example, for fashion content items, the topic module 204 may search for an adjective followed by a noun, but for sports content items, the topic module 204 may search for a verb followed by a noun (e.g., running back).

The topic module 204 updates an external trend index stored in the crawling storage 212 based on the topics identified in the content item and the timing information associated with the content item. The external trend index indicates for each topic the number of times the topic has appeared in content items analyzed by the topic module 204 over time. The number of times a topic has appeared in content items may also be referred to as the number of mentions of the topic.

As an example, for each topic the external trend index may include an identifier of each content item the topic has been found in and the time and date associated with each content item. Hence, when the topic module 204 identifies a topic in a content item being analyzed, the topic module 204 updates the external trend index for the topic to include an identifier of the content item and timing information associated with the content item.

The information stored by the external trend index is referred to as external trend information since it indicates the interest there has been for different topics. If a topic is popular at the moment, it will appear more frequently in content items (e.g., published articles). Based on the external trend information stored in the index, a plot can be generated for each topic that shows the number of mentions of the topic in content items over time.

The topic module 204 also analyzes information made available by the merchant system 102 to users for topics. In one embodiment, the topic module 204 obtains from the merchant system 102 pages (e.g., catalog pages) through which the merchant system 102 offers merchant items to users. The topic module 204 analyzes each page to identify topics included in the page. Similar to the analysis of the content items, for a merchant item page, the topic module 204 categorizes the page and identifies topics included in the page using a topic list and natural language processing.

The topic module 204 updates a page index stored in the merchant storage 214. For an analyzed page, the topic module 204 updates the page index to indicate the topics identified in the page. For example, after analyzing a page, the topic module 204 may include an identifier of the page in the page index along with a list of the topics found by the topic module 204 in the list.

The tracking module 206 tracks user interactions with the merchant system 102 and generates merchant trend information based on the interactions. The tracking module 206 receives from merchant system 102 and/or client devices 106 information indicating interactions performed by users with pages of the merchant system 102. An interaction may be, for example, a user viewing a page, a user searching for a merchant item described in the page, a user requesting a merchant item described in a page, a user adding a merchant item described in the page to an electronic shopping cart, and a user purchasing a merchant item described in the page.

When the tracking module 206 receives information on a user interaction, the tracking module 206 determines from the information the page associated with the interaction, the interactions performed by the user, and timing information associated with the interaction (e.g., when the interaction occurred). The tracking module 206 determines the topics included in the page associated with the interaction based on the information stored in the page index of the merchant storage 214.

The tracking module 206 updates a merchant trend index included in the merchant storage 214 for the topics included in the page. The merchant trend index includes for different topics information as to interactions performed with pages that include the topic. For the topics included in the page, the tracking module 206 identifies the topic in the merchant trend index and includes information indicating the interaction performed and the timing information associated with the interaction.

For example, if a user viewed a page that includes the topic “printed pants,” the tracking module 206 will identify “printed pants” in the merchant trend index and include information that the page was viewed on X date and Y time. The information stored by the merchant trend index is referred to as merchant trend information because it indicates interest users of the merchant system 102 have had in different topics. The merchant trend information is different than the external trend information stored by the external trend index in that the merchant trend information is specific to the interest of users of the merchant system 102. On the other hand, the external trend information is generated based on information from a variety of sources separate from the merchant system 112. Therefore, the external trend information represents general user interest in topics (doesn't only represent merchant system user interest).

The similarity module 208 determines the relationship between topics. For a topic identified by the topic module 204, the similarity module 208 determines whether the topic is related with other topics identified by the topic module 204. To determine whether a topic is related to another topic, the similarity module 208 calculates a relationship score. In one embodiment, to calculate the relationship score, the similarity module 208 analyze the page index to determine the number of times the two topics appeared in the same page of the merchant system 102. Additionally, the similarity module 208 analyzes the external trend index to determine the number of times the two topics appeared in the same content item.

The similarity module 208 calculates the relationship score based on the number of times the two topics appeared in the same page and the number of times the two topics appeared in the same content item. Additional factors may also be used in calculating the relationship score, such the number of times the topics were included in the same search query and the number of times users that access a page including one topic also accessed another page that includes the other topic.

If score is above a threshold, the similarity module 208 determines that the two topics are related. If a determination is made that the two topics are related, the similarity module 208 stores information in the relationship storage 216 that indicates that the two topics are related. The relationship storage 216 stores information indicating which topics are related.

The prediction module 210 processes requests to predict interest for a merchant item. When a request is received from a client device 106 for a prediction of interest in an item, the prediction module 210 identifies from the request a description of the merchant item. For example, for shoes the description may include the brand of the shoes, price, type of shoes (e.g., athletic, flats, boots), color, and target sex (e.g., male or female). The description may also be very general, such as plaid shirt.

The prediction module 210 identifies topics included in the description. In one embodiment, prediction module 210 identifies the topics using a topic list and/or natural language processing as described above with reference to the topic module 204. In another embodiment, when a user of the client device 106 provides the description, the topics are identified in the way the description is provided. For example, the user may provide the description by entering information into various fields on a page. Each field is associated with a different type of topic, such the brand topic, the price topic, etc. Hence, based on the fields in which the user entered information, the prediction module 210 is able to determine the topics of the description.

The prediction module 210 determines a topic score for each identified topic. To determine a topic score for an identified topic, the prediction module 210 determines whether the external trend index of the crawling storage 212 includes external trend information for the identified topic and whether the merchant trend index of the merchant storage 214 includes merchant trend information for the identified topic. In other embodiments, the prediction module 210 only checks for one type of trend information. For example, the user of the client device 106 may request that the predicted interest be determined without using merchant information. As a result, the prediction module 210 will check for external trend information but not for merchant trend information.

If trend information (external and/or merchant trend information) is identified for the topic, the prediction module 210 determines a topic score for the topic based on the trend information. Specifically, for each type of trend information identified, the prediction module 210 determines based on the trend information what the interest has been for the topic over a period of time and whether the interest has been growing or declining (interest growth rate).

For example, from external trend information, the prediction module 210 can determine over the past month how many times the topic has been appearing in content items every week and the rate at which appearances in content items has been growing or declining. Similarly, from merchant trend information, the prediction module 210 can determine over the past month how many interactions have occurred every week with pages including the topic and the rate at which interactions has grown or declined.

The prediction module 210 determines an interest value for the type of trend information identified based on what the past interest in the topic has been and the interest growth rate. The interest value indicates the predicted future interest in the topic based on the trend information. The value may be within a specific range (e.g., between 0 and 10).

The prediction module 210 determines the topic score for the identified topic by combining the interest value determined for the external trend information with the interest value determined for the merchant trend information. In one embodiment, the interest values are combined by averaging the values. One interest value may be given more weight than another. For example, the interest value of the merchant trend information may be given more weight than the external trend information so that interest value more reflects the interest of users of the merchant system 102. The interest values may also be combined, for example, by summing, multiplying, or taking the difference of the two values. In one embodiment, if only one type of trend information was identified for the topic, the topic score is equal to the interest value determined for that type of trend information.

If there is no trend information for the identified topic in the external trend index or the merchant trend index, the prediction module 210 determines the topic score for the identified topic based on one or more related topics. In one embodiment, if trend information exists for the identified topic, but the trend information is not sufficient (e.g., there isn't trend information over a minimum period of time), the prediction module 210 determines the topic score based on related topics.

The prediction module 210 determines one or more topics related to the identified topic. To determine the related topics, the prediction module 210 searches the relationship storage 216 for the identified topic. If the relationship storage 216 includes information indicating that the identified topic is related to one or more other topics. The prediction module 210 identifies the other topics as related topics.

If the relationship storage 216 does not include information for the identified topic, for example because the topic is a new topic, the prediction module 210 determines the related topics based on the other topics included in the merchant item description. In one embodiment, for one or more of the other description topics, the prediction module 210 searches the relationship storage 216 for topics that are related to the description topic and are of the same type as the identified topic. The topics identified in the search are determined by the prediction module 210 to be related to the identified topic.

For example, assume the identified topic is a brand type of topic and another topic included in the merchant item description is “high end shoes.” The prediction module 210 will search the relationship storage 216 for topics related to “high end shoes” and that are brand type of topics. The prediction module 210 may identify a couple of expensive brands based on the search and will determine that those expensive brands are topics related to the identified topic.

In another embodiment, instead of the prediction module 210 determining the related topics, the prediction module 210 transmits a request to the client device 106 that provided the merchant item description. The requests indicates that the user of the client device provide topics that are related to the identified topic. The topics provided by the user based on the request are identified as related topics by the prediction module 210.

For each related topic, the prediction module 210 determines at least one interest value for the topic using trend information as described above. The prediction module 210 combines the interest values of the related topics to determine the topic score for the identified topic.

The prediction module 210 determines a predictive score for the merchant item by combining the topics scores of the topics included in the merchant item description. The predictive score may be within a specific range (e.g., 0 to 10). In one embodiment, the higher the predictive score, the greater the interest is likely to be for the merchant item. In one embodiment, the prediction module 210 combines the topic scores by averaging them. The prediction module 210 may give different weights to the topics scores when combining them. For example, the prediction module 210 may give more weight to a score for a brand topic than to score for a color topic. In other embodiments, the topic scores may be combined by summing or multiplying the topic scores together. The prediction module 210 transmits the predictive score to the client device 106 that provided the request and the merchant item description.

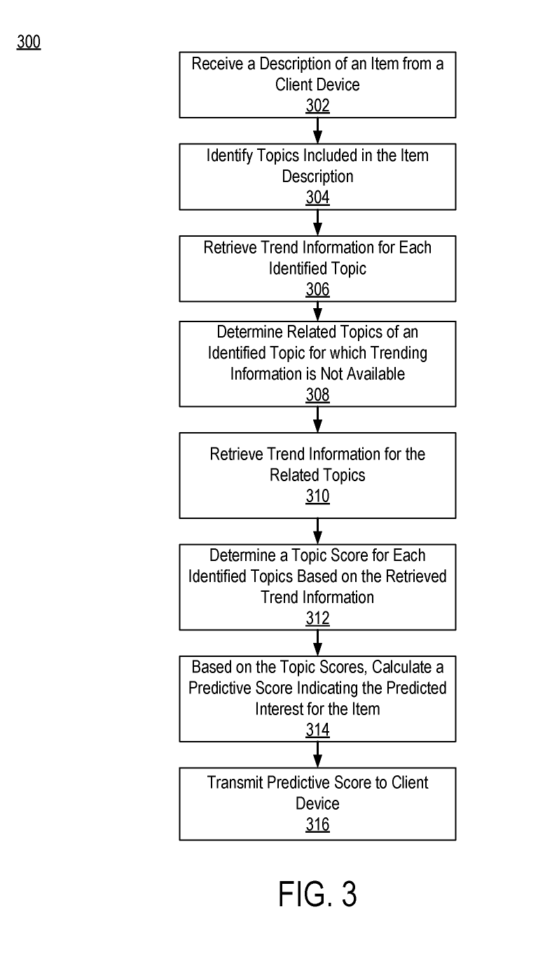

FIG. 3 is a flow chart 300 illustrating operations of the predictive demand system 108 in predicting demand for an item according to one embodiment. Those of skill in the art will recognize that other embodiments can perform the steps of FIG. 3 in different orders. Moreover, other embodiments can include different and/or additional steps than the ones described herein.

The predictive demand system 108 receives 302 from a client device a description of the item. The predictive demand system 108 identifies 304 topics included in the item description. For each identified topic, the predictive demand system 108 retrieves 306 trend information generated for the topic. If trend information is not available for the identified topic, the predictive demand system 108 determines 308 topics related to the identified topic based on the other topics included in the item description. The predictive demand system 108 retrieves 310 trend information for the related topics. The predictive demand system 108 determines 312 a topic score for the topic based on the trend information.

The predictive demand system 108 calculates 314 a predictive score for the item based on the topic score calculated for the topics included in the item description. The predictive score indicates the predicted interest in the item. The predictive demand system 108 transmits 316 the predictive score to the client device 106.

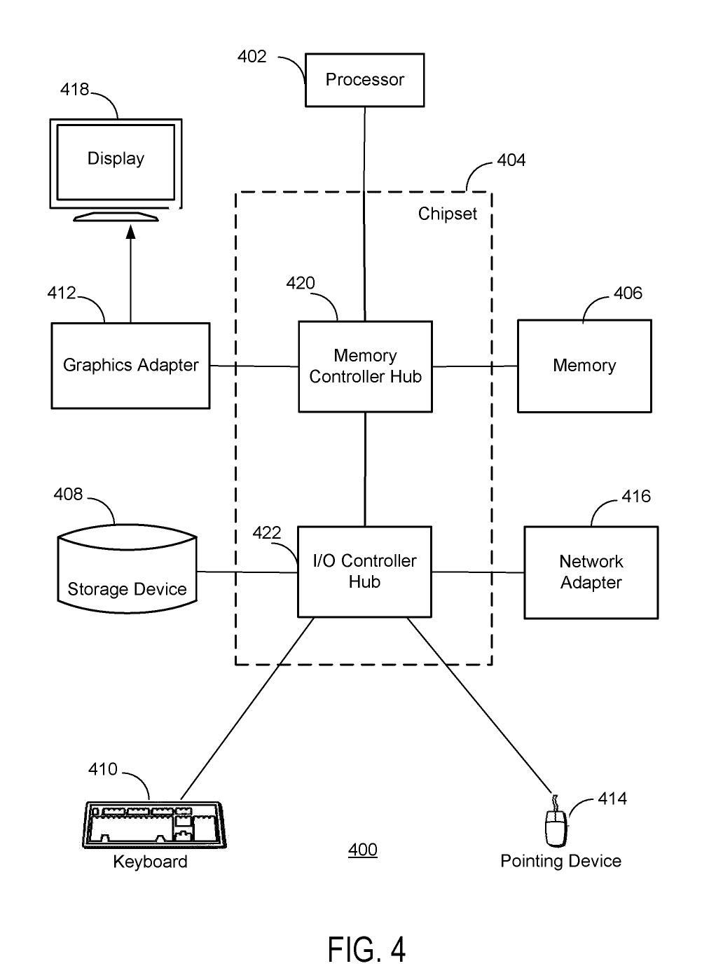

FIG. 4 is a high-level block diagram illustrating a functional view of a typical computer system (may also be referred to as a computer database system) for use as one of the entities illustrated in the environment 100 of FIG. 1 according to an embodiment. Illustrated are at least one processor 402 coupled to a chipset 404. Also coupled to the chipset 404 are a memory 406, a storage device 408, a keyboard 410, a graphics adapter 412, a pointing device 414, and a network adapter 416. A display 418 is coupled to the graphics adapter 412. In one embodiment, the functionality of the chipset 404 is provided by a memory controller hub 420 and an I/O controller hub 422. In another embodiment, the memory 406 is coupled directly to the processor 402 instead of the chipset 404.

The storage device 408 is a non-transitory computer-readable storage medium, such as a hard drive, compact disk read-only memory (CD-ROM), DVD, or a solid-state memory device. The memory 406 holds instructions and data used by the processor 402. The pointing device 414 may be a mouse, track ball, or other type of pointing device, and is used in combination with the keyboard 410 to input data into the computer system 200. The graphics adapter 412 displays images and other information on the display 418. The network adapter 416 couples the computer system 400 to the network 110.

As is known in the art, a computer 400 can have different and/or other components than those shown in FIG. 4. In addition, the computer 400 can lack certain illustrated components. For example, a computer system 400 acting as a predictive demand system 108 may lack a keyboard 410 and a pointing device 414. Moreover, the storage device 408 can be local and/or remote from the computer 400 (such as embodied within a storage area network (SAN)).

The computer 400 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 408, loaded into the memory 406, and executed by the processor 402.

The types of computer systems 400 used by the entities of FIG. 1 can vary depending upon the embodiment and the processing power used by the entity. For example, a client device 106 may be a mobile phone with limited processing power, a small display 418, and may lack a pointing device 414. The predictive demand system 108, in contrast, may comprise multiple blade servers working together to provide the functionality described herein.

The particular naming of the components, capitalization of terms, the attributes, data structures, or any other programming or structural aspect is not mandatory or significant, and the mechanisms that implement the embodiments described may have different names, formats, or protocols. Further, the systems may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain embodiments described herein include process steps and instructions described in the form of an algorithm. It should be noted that the process steps and instructions of the embodiments could be embodied in software, firmware or hardware, and when embodied in software, could be downloaded to reside on and be operated from different platforms used by real time network operating systems.

The embodiments described also relate to apparatuses for performing the operations herein. An apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present embodiments are not described with reference to any particular programming language. It is appreciated that a variety of programming languages may be used to implement the teachings of the embodiments as described herein.

The embodiments are well suited for a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the embodiments is intended to be illustrative, but not limiting.

1. A computer-implemented method for predicting interest in an item, the method comprising:
receiving, by a computer database system from a user, a description of an item including a first topic and a second topic;
identifying, by the computer database system, trend information associated with the first topic indicating interest in the first topic;
determining, by the computer database system, a third topic related to the second topic;
identifying, by the computer database system, trend information associated with the third topic indicating interest in the third topic;
determining, by the computer database system, a measure based on the trend information associated with the first topic and the trend information associated with the third topic, the measure indicating predicted interest in the item; and
transmitting, by the computer database system, the measure to a client device associated with the user.

2. The method of claim 1, wherein third topic is not included in the description of the item.

3. The method of claim 1, wherein the measure is determined based on the trend information associated with the third topic in response to determining that trend information associated with second topic is not available.

4. The method of claim 1, wherein the measure is determined based on the trend information associated with the third topic in response to determining that trend information associated with second topic has not been generated over a minimum period of time.

5. The method of claim 1, wherein determining the third topic comprises:
determining the third topic is related to the second topic based on the first topic being related to the third topic.

6. The method of claim 1, wherein the third topic is determined to be related to the second topic based on the first topic being related to the third topic and the third topic being of a same type as the second topic.

7. The method of claim 1, further comprising:
transmitting to the client device a request for topics related to the second topic; and
receiving the third topic from the client device based on the request.

8. The method of claim 1, wherein the trend information associated with the first topic is generated by analyzing a plurality of content items received from a plurality of sources and identifying the first topic in the plurality of content items.

9. The method of claim 1, wherein the trend information associated with the first topic is generated by analyzing a plurality of user interactions with a merchant system that offers items and determining that the plurality of user interactions are associated with the first topic.

10. The method of claim 1, wherein the trend information associated with the first topic comprises external trend information and merchant trend information, the external trend information generated based on identifying the first topic in content items obtained from a plurality of sources and the merchant trend information generated based on user interaction with a merchant system that are associated with the first topic.

11. The method of claim 10, wherein determining the measure comprises:
determining a first topic score for the first topic based on the external trend information and the merchant trend information, the first topic score indicating predicted interest in the first topic;
determining a second topic score for the second topic based on the trend information associated with the third topic, the second topic score indicating predicted interest in the second topic; and
combining the first topic score and the second topic score.

12. A non-transitory computer-readable storage medium storing computer-executable instructions which when executed by a computer database system cause the computer database system to perform steps comprising:
receiving, from a user, a description of an item including a first topic and a second topic;
identifying trend information associated with the first topic indicating interest in the first topic;
determining a third topic related to the second topic;
identifying trend information associated with the third topic indicating interest in the third topic;
determining a measure based on the trend information associated with the first topic and the trend information associated with the third topic, the measure indicating predicted interest in the item; and
transmitting the measure to a client device associated with the user.

13. The computer-readable storage medium of claim 12, wherein the measure is determined based on the trend information associated with the third topic in response to determining that trend information associated with second topic is not available.

14. The computer-readable storage medium of claim 12, wherein the measure is determined based on the trend information associated with the third topic in response to determining that trend information associated with second topic has not been generated over a minimum period of time.

15. The computer-readable storage medium of claim 12, wherein determining the third topic comprises:
determining the third topic is related to the second topic based on the first topic being related to the third topic.

16. The computer-readable storage medium of claim 12, wherein the third topic is determined to be related to the second topic based on the first topic being related to the third topic and the third topic being of a same type as the second topic.

17. The computer-readable storage medium of claim 12, wherein the computer-executable instructions further cause the processor to perform steps comprising:
transmitting to the client device a request for topics related to the second topic; and
receiving the third topic from the client device based on the request.

18. The computer-readable storage medium of claim 12, wherein the trend information associated with the first topic is generated by analyzing a plurality of content items received from a plurality of sources and identifying the first topic in the plurality of content items.

19. The computer-readable storage medium of claim 12, wherein the trend information associated with the first topic is generated by analyzing a plurality of user interactions with a merchant system that offers items and determining that the plurality of user interactions are associated with the first topic.

20. The computer-readable storage medium of claim 12, wherein the trend information associated with the first topic comprises external trend information and merchant trend information, the external trend information generated based on identifying the first topic in content items obtained from a plurality of sources and the merchant trend information generated based on user interaction with a merchant system that are associated with the first topic.
